(19) United States
(12) Patent Application Publication
(10) Pub. No.: US 2004/0055680 A1
(43) Pub. Date: Mar. 25, 2004

(54) Tire having a metallic colored surface composition

(76) Inventors: Alain Cottin, Clermont-Ferrand (FR); Georges Peyron, Riom (FR)

Correspondence Address: BAKER & BOTTS, 30 ROCKEFELLER PLAZA, NEW YORK, NY, 10112

(21) Appl. No.: 10/609,512

(22) Filed: Jun. 30, 2003

Related U.S. Application Data
(63) Continuation of application No. PCT/EP01/15191, filed on Dec. 21, 2001.

(30) Foreign Application Priority Data
Dec. 29, 2000 (FR) FR 00/17345

(51) Int. Cl. B60C 1/00

(52) U.S. Cl. 152/151

(57) ABSTRACT

The present invention relates to colored compositions used as coatings for tires. The present invention relates to a tire having an outer rubber surface based at least in part on essentially unsaturated diene elastomers, which is covered with the colored coating. The coating has at least one layer in contact with the air and comprises a composition comprising a majority proportion of polyurethane produced from a polyol selected from the group consisting of aliphatic polyethers, aliphatic polyesters, polyethers having a main chain that is semi-aromatic and polyesters having a main chain that is semi-aromatic, and flakes of mica in an amount of between 10 and 80 parts of flakes per hundred parts of dry polyurethane, phr, wherein the bond between the elastomer and the polyurethane being produced due to the polar functions. The present invention also relates to methods of producing the composition and the tire comprising the composition.

### CROSS REFERENCE TO RELATED APPLICATIONS

The present application is a continuation of International Patent Application No. PCT/EP01/15191, filed Dec. 21, 2001, published in French on Jul. 11, 2002 as International Patent Publication No. WO 02/053662, which claims priority to French Application No. FR 00/17345, filed Dec. 29, 2000, all of which are incorporated in their entireties herein.

The present invention relates to metallic color compositions for the manufacture of tires and, in particular, compositions for the outer surface of tires.

Hereafter, the term “colored” means all other colors including white, but excluding the color black. Furthermore, the term “metallic color” is defined as all the light or dark metallic shades of any color other than black.

The compositions of the present invention are intended for use on the surfaces of tires independent of the nature and the composition of the rubber mixes upon which the compositions are to be deposited. In particular, the compositions of the present invention are intended for use on “non-wearing” surfaces of tires. The “non-wearing” surfaces of tires are not generally in contact with the road under normal conditions of use. Thus, the colored compositions of the present invention may be used for decorative and marking purposes on the outer surface of a tire sidewall or the bottoms of tread patterns of the tread.

### BACKGROUND OF THE INVENTION

Due to the presence of double bonds on their molecular chains, vulcanized rubber compositions comprising both natural and synthetic diene rubbers are susceptible to rapid deterioration after prolonged exposure to the atmosphere. Protection from oxidation and ozonolysis mechanisms have been described in the following documents: FR-A-1 358 702; FR-A-1 508 861; U.S. Pat. No. 3,419,639; FR-A-2 553 782; “Antidegradants for tire applications” in “Tire compounding”, Education Symposium No. 37 (ACS), Cleveland, Communication I, October 1995; “Non-blooming high performance antidegradants”, Kaut. Gummi Kunst., 47, No. 4, 1994, 248-255; “Antioxidants” in Encycl. Polym. Sci. and Eng., 2nd Edition, Vol. 2, 73-91; “Protection of rubber against ozone”, RCT (Rubber Chem. Technol.) Vol. 63, No. 3, 1990, 426-450). These complex degradation mechanisms include various effects following the breakage of the double bonds and oxidation of the sulfur bridges. Oxidation causes stiffening and embrittlement of vulcanized rubber compositions. Ozone attack causes incipient surface cracking or fissures, which can develop and spread as a function of the nature and the severity of the static or dynamic stresses imposed on the vulcanized rubber compositions. The degradation mechanisms described above can be further accelerated by heat from thermo-oxidation, or light from photo-oxidation (“Photo-oxidation and stabilization of polymers”, Trends in Polym. Sci., Vol. 4, No. 3, 1996, 92-98; “Degradation mechanisms of rubbers”, Int. Polym. Sci. and Technol., Vol. 22, No. 12, 1995, 47-57).

The aging phenomena described above can be inhibited using various antidegradants, antioxidants or antiozonants. Compounds that function both as antioxidants and antiozonants have been identified. Many are derivatives of quinoline, for example 2,2,4-trimethyl-1,2-dihydroquinoline (“TMQ”). Derivatives of p-phenylenediamine (“PPD”), for example, N-1,3-dimethylbutyl-N′-phenyl-p-phenylenediamine (“6-PPD”) and N-isopropyl-N′-phenyl-p-phenylenediamine (“I—PPD”), also function as antioxidants and antiozonants. The PPD derivatives can be more potent than the TMQ derivatives. The TMQ and PPD-type antidegradants, which may be used in combination, are in widespread use, added systematically to conventional rubber compositions (“Antidegradants for tire applications” in “Tire compounding”, Education Symposium No. 37 (ACS), Cleveland, Communication I, October 1995; “Non-blooming high performance antidegradants”, Kaut. Gummi Kunst., 47, No. 4, 1994, 248-255; “Protection of rubber against ozone”, RCT (Rubber Chem. Technol.) Vol. 63, No. 3, 1990, 426-450). The rubber compositions may be filled, at least in part, with carbon black, imparting a characteristic black color.

The agents described above, in particular the TMQ or PPD derivatives, are not light-fast. Under UV radiation, they produce colored chemical species which cause adverse color changes in the rubber compositions, staining the rubber compositions dark brown. Due to the staining effect, these agents cannot be used for white, clear or colored compositions. Furthermore, these agents can naturally migrate out of rubber compositions and stain the white, clear or colored compositions that may be in contact with the rubber composition containing these agents. Thus, these agents cannot be used for rubber compositions that are in proximity to white, clear or colored compositions.

To limit degradation due to ozone, elastomeric compositions commonly incorporate waxes which provide supplementary protection, statically, by the formation of a protective coating at the surface. However, the waxes can also migrate to the surface of the articles and can modify the external appearance of the surfaces of the elastomeric compositions by staining them or making them dull. This phenomenon is referred to as “efflorescence” of the waxes.

The development of colored compositions intended to cover the outer surface of tires has been significantly complicated by the staining caused by antioxidants, antiozonants and waxes present in the other compositions used in tires.

The majority of solutions proposed in the past to address the problem of staining was based on the use of colored rubber-based compositions having constituents that are highly impermeable. It is well known in the art to use butyl rubber for its property of impermeability. However, the use of butyl rubber has created a number of problems.

For example, publication CA-2 228 692 describes a white sidewall composition using an elastomeric base comprising primarily butyl rubbers to act as a barrier to staining antioxidants. However, it is known in the art that large proportions of butyl rubber in compositions create problems of adhesion with the other compositions present in the tire. The interface obtained between the white sidewalls and the other compositions present in the tire is fragile. The compositions for white sidewalls can be laid only on very limited parts of the sidewall, which are not subjected to stress in order to avoid detachment at the interfaces.

Alternatively, other solutions have consisted of producing rubber compositions intended to be used in the mass, and not only at the surface. These solutions dispense with the presence of antioxidants based on PPD or TMQ derivatives within the rubber compositions. Since the PPD and TMQ derivatives are very effective, replacement of the antidegradants requires complex protection systems, such as the examples described in publication WO 99/02590. In addition, due to the high performance of PPD or TMQ derivatives, it is generally not possible to replace them without using butyl rubber, the drawbacks of which have already been discussed.

The present invention aims to overcome all these disadvantages by providing a novel colored composition, based on polyurethane.

### SUMMARY OF THE INVENTION

The inventors have surprisingly discovered that certain polyurethanes may form the base of a colored composition. This composition can advantageously be laid on the vulcanized tire after treatment of the tire surface to provide reactive polar functions. The polyurethane adheres satisfactorily to the surface of tire and there is no limitation on the thickness of the layer added to the tire.

The present invention provides colored compositions used as coatings for tires and a tire having an outer rubber surface based at least in part on essentially unsaturated diene elastomers, which is covered with the colored coating. The coating has at least one layer in contact with the air and comprises a composition comprising a majority proportion of polyurethane produced from a polyol, wherein the polyol selected from the group consisting of aliphatic polyethers, aliphatic polyesters, polyethers having a main chain that is semi-aromatic and polyesters having a main chain that is semi-aromatic, and flakes of mica in an amount of between 10 and 80 parts of flakes per hundred parts of dry polyurethane (phr), wherein the bond between the elastomer and the polyurethane results from the interaction of the polyurethane with the polar functions on the elastomer. The present invention also relates to methods of producing the composition and the tire comprising the composition.

### DETAILED DESCRIPTION OF THE INVENTION

According to the invention, the tire has at least part of its outer rubbery surface, based on essentially unsaturated diene elastomers, which is covered with a colored coating. The coating has at least one layer in contact with the air and comprises a composition comprising a majority proportion of polyurethane produced from a polyol, wherein the polyol is selected from the group consisting of aliphatic polyethers, aliphatic polyesters, polyethers having a main chain that is semi-aromatic and polyesters having a main chain that is semi-aromatic. The composition further comprises flakes of mica in an amount of between 10 and 80 parts of flakes per hundred parts of dry polyurethane (phr), more preferably between 20 and 80 phr. The bond between the elastomer and the polyurethane results from the interaction of the polyurethane with polar functions on the surface of the elastomer. The polar functions located at the surface of the elastomer are more effective when they have at least one mobile hydrogen capable of reacting with the coating composition to form covalent bonds.

This coating, which comprises a polyurethane base and flakes of mica, effectively slows down the degradation due to oxidation and ozone and very greatly limits the migration of antioxidants towards the surface. As a result, the coating can retain its color and prevent the migration of waxes towards the surface by barrier effect, thereby avoiding efflorescence and enabling the coating to retain its surface appearance.

Advantageously, the polyurethane has a glass transition temperature less than or equal to −20° C. and an elongation at break greater than or equal to 100%.

The glass transition temperature of a polymer is the temperature at which the mechanical behavior of the polymer changes from vitreous, rigid and brittle behavior to rubbery behavior.

The layer permits the formation of a continuous colored coating, which is flexible and adheres to the surface of the tire. The rubbery behavior of the coating obtained makes it possible to withstand all the deformations experienced after the manufacture of the tires and, in particular, upon the inflation thereof and in its later use.

The process of the present invention is aimed at depositing a colored coating on the outer surface of a tire, where the composition of the outer surface is based on essentially unsaturated diene elastomers.

“Diene” elastomer or rubber is defined as an elastomer resulting at least in part, i.e. a homopolymer or a copolymer, from diene monomers. Monomers bear two double carbon-carbon bonds, whether they are conjugated or not.

In general, an “essentially unsaturated” diene elastomer is defined as a diene elastomer resulting at least in part from conjugated diene monomers, having a content of members or units of diene origin (conjugated dienes) which is greater than 15% (mol %).

For example, diene elastomers, such as butyl rubbers or copolymers of dienes and of alpha-olefins of the EPDM (ethylene-propylene-diene terpolymer) type, do not fall within the preceding definition, and may be described as “essentially saturated” diene elastomers. These diene elastomers have a low or very low content of units of diene origin, which is less than 15%.

In a first phase, the process comprises treating the outer surface of the vulcanized tire to be protected with a solution containing a functionalizing agent in order to functionalize the diene elastomers and permit application or gluing of a composition based on polyurethane of the present invention. The tire may or may not be mounted and inflated prior to the treatment.

The functionalizing agent is preferably selected from the group consisting of alkaline hypochlorites and alkaline-earth hypochlorites in hydrochloric acid, in particular sodium, potassium or calcium hypochlorites, and trichloroisocyanuric acid, (TIC). These agents stimulate chloration and oxidation at the surface of the rubber mix.

The functionalizing agents are in a concentration of from 1-5% by weight. The hypochlorites may be dissolved in water and the TIC may be dissolved in an organic solvent, such as ethyl acetate. Both the water and the organic solvent have the advantage of evaporating easily.

The initial treatment makes the rubber surface polar and functionalizes it so as to permit very good adhesion of the layer of polyurethane. The treatment permits the formation of covalent bonds between the polyurethane and the essentially unsaturated diene elastomers of the rubber mix due to the polar functions created. The TIC also makes it possible to improve the wetting, which further promotes adhesion of the layer of polyurethane.

The treatment with the functionalizing agents may be performed at ambient temperature, with a brush or a roller, or by spraying with a spray-gun.

The solution of functionalizing agent is left to dry for 10 to 30 minutes to allow for the chemical reaction with the rubber surface to take place and to allow the solvent to evaporate. The drying step may be accelerated by heating the surface of the tire. However, the surface temperature must not exceed 60° C. to avoid migration of the polar functions formed on the surface towards the inside of the rubber mix. This migration would prevent the polar functions from being accessible or available in order to produce bonds with the polyurethane.

Subsequent to drying, a thin layer of the composition of the invention based on polyurethane is applied to the surface treated-tire by means appropriate for the application of the coating.

The composition based on an aqueous dispersion of polyurethane comprises flakes of mica in an amount of between 10 and 80 parts per hundred parts of dry polyurethane, which will be referred to as “phr” by analogy with the units used in elastomeric compositions. Preferably, the amount of mica flakes is between 20 and 50 phr.

In fact, the flakes of mica impart a barrier function in the composition and are used in a minimum quantity to obtain correct coloration of the composition as described in the examples.

The flakes of mica may be used alone or in a blend with other fillers selected, in particular, from the groups consisting of titanium dioxide, zinc monoxide, zinc sulfide, barium sulfate and calcium carbonates.

The flakes of mica may or may not be covered with a mineral oxide, for example titanium dioxide. The flakes of mica may be covered synthetically with a fine layer of titanium dioxide.

The covered flakes of mica may appear pearlized or have a metallic-effect, with colors ranging from silvery white to all the colors of the rainbow. Utilization of the high refractive index of the layer of titanium dioxide makes it possible to obtain these shades of color. The flakes of mica may also be coated with titanium dioxide and an additional colorant, such as iron (III) oxide or chromium (III) oxide, to combine the action of the pearlized pigment and the coloring pigment.

The use of non-covered flakes of mica, which are white, can also be used to allow introduction into the composition of any coloring pigment or optical brightening agent in order to obtain a composition of a more luminous white or of another color. A minimum amount of 5% pigment or brightening agent relative to the quantity of mineral filler is recommended in order to obtain the desired coloration. These two fillers may be used jointly or in combination with other white or coloring fillers.

Any type of coloring agent known to the person skilled in the art may also be employed for the compositions of the present invention. The coloring agent may be organic or inorganic, soluble or insoluble in the compositions according to the present invention. Examples of mineral coloring agents include powdered metals, e.g. powdered copper or aluminum, various metallic oxides, e.g. silicates, aluminate, titanates, iron oxides or hydroxides, and mixed oxides of different metallic elements such as Co, Ni, Al or Zn. Organic coloring pigments such as indanthrones, diketo-pyrrolo-pyrroles or diazo condensates, and organometallic pigments such as phthalocyanines may also be used in the present invention.

In an embodiment of the invention, the composition further comprises flakes of aluminum in an amount greater than or equal to 10% of the content of flakes of mica, wherein the content of flakes of mica remains in the majority relative to the content of flakes of aluminum. These proportions of mica and aluminum reinforce the barrier effect of the coating and improve the persistence of the color of the coating over time.

The color of the compositions according to the invention can thus vary within a very wide range, for example different shades of red, orange, green, yellow, blue or alternatively brown or gray.

Reinforcing fillers, such as carbon black or silica, added to the present composition impart other properties to the compositions according to the invention, as long as the color of the filler does not modify or adversely change the desired coloration of the composition. The presence of carbon black in a very small proportion, i.e. a few phr, allows one to obtain a dark red, dark blue or dark green coloration with red, blue or green pigments.

The polyurethane used in the dispersion is produced from a polyol selected from the group consisting of aliphatic polyethers, apliphatic polyesters, polyethers having a main chain that is semi-aromatic and polyesters having a main chain that is semi-aromatic, ensuring that the coating is not susceptible to ozone. The polyurethane has a glass transition temperature less than or equal to −20° C. and an elongation at break greater than or equal to 100% in order to exhibit rubbery behavior and coherent elasticity in accordance with the tire to resist the stresses to which the tire may be subjected.

Preferably, a polyurethane having an elongation at break greater than 200% is used.

The elongation at break of the colored composition based on polyurethane is equal to or greater than 250%, preferably between 250% and 750%.

The polyurethanes according to the invention may be obtained from:

a polyol of a molecular weight of between 500 and 4000 g based on a polyester, such as polyethylene adipate, a polycarbonate, or a polycaprolactone, or based on a polyether, such as a polypropyleneglycol, a polytetramethyleneglycol or a polyhexamethyleneglycol;

a polyisocyanate of functionality 2, such as toluene diisocyanate (TDI), diphenyl methane diisocyanate (MDI), dicyclohexyl methane diisocyanate, cyclohexyl diisocyanate and isophorone diisocyanate, or of functionality 3, such as a triisocyanate obtained by trimerization of one of the diisocyanates mentioned above or of a functionality of between 2 and 3, such as a liquid polyisocyanate derived from MDI;

and, optionally, an extender, such as a diamine or a diol dissolved in the aqueous phase of the polyurethane dispersion.

Some of the polyurethanes mentioned above have free isocyanate groups, which generally make it possible to produce a bond with a polar surface having reactive mobile hydrogens. Other polyurethanes are self-crosslinkable by formation of azomethine or by autooxidation, such as described in the communication “New polymer synthesis for (self) crosslinkable urethanes and urethanes/acrylics” presented by Ad. OVERBEEK EUROCOAT 97 at Lyon Eurexpo, 23-25 Sept. 97.

The presence of chlorinated or oxidized polar functions has been surprisingly found to be sufficient to permit the adhesion of the polyurethane, even in the absence of free isocyanate. The coating is retained despite the stresses and the strains to which the tire is subjected, as shown by the examples. It is advantageous to be able to use such polyurethanes, since the free isocyanate groups adversely affect the stability of the polyurethane in water. Nevertheless, polyurethanes containing free isocyanate groups may be used if they are protected within the particles of the aqueous dispersion. It may be noted that coatings such as described in application EP-0 728 810 of the prior art do not react with polar functions and thus such a surface treatment is of no interest for such compositions.

The composition further comprises at least one thickening agent which may be an associative polyurethane in a proportion of from 0.5 to 5 phr. The quantity of associative polyurethane depends on the viscosity obtained when the mixture of water, polyurethane, and filler is present. The desired viscosity is dependent on the means selected for depositing the composition, e.g. spray-gun, scraper, brush, etc.

The composition may further comprise agents that impart anti-bacterial, stabilizing, and/or fungicidal properties to the composition.

The concentration of polyurethane in the aqueous dispersion of polyurethane is preferably between 10 and 50% according to the location of the surface of the tire to be protected. A concentration below 10% is too low to obtain the desired effects and at a concentration greater than 50% is very viscous and difficult to apply.

The concentration of the polyurethane is also dependent on the desired thickness of the coating. The highest concentration is selected in order to reduce the number of layers to be applied and conversely.

The layer is allowed to dry until the polyurethane has completely reacted with the reactive functions at the surface of the rubber mix in order to adhere to the treated surface and the water or solvent has evaporated completely. At ambient temperature, the drying time may be about one hour. The drying time can be reduced to a few minutes by heating the surface of the tire to a temperature not exceeding 60° C., by circulating hot air around the tire surface.

Depending on the means used to deposit the composition, the thickness of the coating formed after drying said composition can be varied. Good results are obtained with dry coatings having a thickness greater than or equal to 5 μm.

However, the desired thickness may vary according to the surface where the coating is applied. A thickness of 5 μm to 50 μm, for example, may be sufficient on the tire sidewalls and a greater thickness may be required, for example from 100 μm to 500 μm, for the bottoms of the grooves of tread patterns of the tires or in the zones where a protective effect of the coating is required with respect to the atmosphere.

The colored coating cannot effectively withstand the different attacks on those parts of the tire which are in permanent contact with the ground.

The invention is illustrated in non-limitative manner by the following examples, which, however, do not constitute a limitation to the scope of the invention. Other characteristics and advantages of the invention will become apparent on reading the examples of embodiment of a tire according to the invention and the implementation process.

### EXAMPLES

### Colorimetric Properties

The calorimetric values were determined using a SPECTRO-PEN spectrocolorimeter from Dr. LANGE in configuration D65/10 (daylight; angle of observation 10°). The colorimetric properties were measured in accordance with the instruction manual for the calorimeter, by analyzing the reflectance spectrum of the test pieces.

These measurements were transferred to the “CIE LAB” system of the 3 three-dimensional colorimetric coordinates L*, a*, b* (with an uncertainty of 0.1), in which system:

the a* axis represents the green-red chromaticity coordinate, with a scale from −100 (green) to +100 (red);

the b* axis represents the blue-yellow chromaticity coordinate, with a scale from −100 (blue) to +100 (yellow);

the L* axis represents the luminosity coordinate, with a scale from 0 (black) to 100 (white);

ΔE=[(ΔL*)2+(Δa*)²+(Δb*)²]^{1/2} represents the overall average calorimetric deviation of each sample relative to a non-aged control; the higher ΔE is, the more the color of the composition has changed.

It is clear that, when a*, b*, L* are measured, their relative variation to one another have to be taken into account to determine whether the color of the coating has remained within the same range as the initial color of the latter.

In the colorimetry tests, the test pieces used were non-standardized test pieces consisting of strips of rubber of a reference composition A of dimensions 150×150 mm on which three strips of coating of composition B to be tested, of width 25 mm, spaced apart from each other have been deposited (after a layer of TIC has been deposited) using a scraper which makes it possible to obtain a dry coating thickness of one tenth of a millimeter.

These test pieces were left static exposed to the ambient external air, for a given period. The painted face comprising the compositions to be tested were located in the open air.

The reference composition, which will be referred to as composition A hereafter, was a support composition similar to those used in sidewalls of tires filled with carbon black. These examples in no way restrict the results obtained upon superposition of the colored compositions according to the invention on the conventional compositions, given that the demonstration essentially relates to the presence of antioxidants in these compositions.

The formulation of composition A was as follows, with all the parts being expressed as parts by weight, and in which the elastomer was constituted by a 35/65 blend of natural rubber and polybutadiene:

| | |
|---|---|
| Elastomer | 100 |
| Carbon black (N660) | 60 |
| Aromatic oil | 20 |
| Wax (a) | 1 |
| Zinc oxide | 3 |
| Stearic acid | 1 |
| TMQ | 1 |
| 6-PPD | 3 |
| Sulphenamide (b) | 0.95 |
| Sulfur | 1.6 |

(a) antiozonant wax (Redezon 500, from Repsol)
(b) sulphenamide: N-cyclohexyl-2-benzothiazyl sulphenamide.

The compositions B used in the examples had the following base composition:

Solution B:

50/50 mixture of two dispersions (35%) of polyurethane produced respectively from an aliphatic polyester having respectively an amount of elongation greater than 700%, sold by AVECIA sas, under the name NeoRez R-550 and NepRez R-987, this mixture being produced in order to avoid obtaining a sticky product which cannot be deposited using the scraper

associative polyurethane 1 phr of COATEX DV 202

TIC Solution: 3% trichloroisocyanuric acid in ethyl acetate.

### Example 1

The aim of this example was to show the retention over time of the coloration of a coating according to the invention, produced from a composition B1.

Composition B1 comprised the base formulation B with added flakes of mica (1) in an amount of 10 parts of flakes per one hundred parts of polyurethane dispersion, or approximately 28 phr relative to dry polyurethane and about 2.8 phr (for the dry polyurethane) of a green colorant (2).

(1) Flakes of mica coated with titanium dioxide sold by MERCK under the name Iriodine 235 Pearl Green Rutile.

(2) Green pigment sold by CIBA under the name Pigment Vert GS in the UNISPERSE range.

“To” being the date of deposition of the coating, the results obtained are set forth in Table I below.

TABLE I

| Date | To | To + 30 d | To + 60 D | To + 90 d |
|---|---|---|---|---|
| L* | 46.7 | 38.7 | 34.0 | 37.4 |
| a* | −38.6 | −27.8 | −23.3 | −21.4 |
| b* | 1.3 | 5.1 | 7.8 | 7.9 |
| Coating appearance | — | No staining | No staining | No staining |

The results show that the coating did not exhibit stains even after 90 days of ambient air exposure, indicating that the composition of the coating had effectively slowed down the oxidation and attack by ozone.

It will be noted that the luminosity (L*) over time had slightly decreased. However, the chromaticities had changed, moving away from green (a*) and moving towards yellow (b*). These different variations remained in the same proportions for the three values measured, therefore, made the intensity of the green decrease at the same time as the luminosity, so that overall the coloration remained green.

1. A tire having an outer rubber surface based at least in part on essentially unsaturated diene elastomers, said outer rubber surface covered with a colored coating bonded thereto, said colored coating having at least one layer in contact with air and comprising a composition, wherein said composition comprises:
(1) polyurethane in a majority proportion; and
(2) flakes of mica in an amount of between 10 and 80 parts of flakes per hundred parts of dry polyurethane (phr),
wherein the polyurethane is produced from a polyol selected from the group consisting of aliphatic polyethers, aliphatic polyesters, polyethers having a main chain that is semi-aromatic and polyesters having a main chain that is semi-aromatic,
and the bond between the elastomers and colored coating results from interaction between the polyurethane and polar functions on the elastomers.

2. The tire according to claim 1, wherein the amount of flakes of mica is between 20 and 50 phr.

3. The tire according to claim 1, wherein the colored composition has an elongation at break equal to or greater than 250%.

4. The tire according to claim 3, wherein the colored composition has an elongation at break between 250% and 750%.

5. The tire according claim 1, wherein the polyurethane has a glass transition temperature less than or equal to −20° C. and an elongation at break greater than or equal to 100%.

6. The tire according to claim 5, wherein the polyurethane has an elongation at break of greater than 200%.

7. The tire according to claim 1, wherein the polyurethane is self-crosslinkable.

8. The tire according to claim 1, wherein the polar functions are chlorinated or oxidized functions.

9. The tire according to claim 1, wherein the flakes of mica are covered with titanium dioxide.

10. The tire according to claim 1, wherein the composition comprises flakes of mica in combination with white fillers selected from the group consisting of titanium dioxide, zinc monoxide, sulfur monoxide, barium sulfate and calcium carbonates.

11. The tire according to claim 1, wherein the colored composition comprises at least one colored pigment in an amount greater than 5% of the content of flakes of mica.

12. The tire according to claim 1, wherein the composition further comprises flakes of aluminum in an amount greater than or equal to 10% of the content of flakes of mica, wherein the amount of flakes of mica remains in the majority relative to the amount of flakes of aluminum.

13. The tire according to claim 11, wherein the colored pigment is present in an amount greater than 25% of the amount of flakes of mica.

14. The tire according to claim 1, wherein the composition further comprises an optical brightener in an amount greater than 5% of the amount flakes of mica.

15. The tire according to claim 1, wherein the coated outer surface of the tire is an outer surface of the tread.

16. The tire according to claim 1, wherein the outer surface of the tire is a surface of the bottoms of tread pattern grooves of the tread.

17. The tire according to claim 1, wherein the outer surface of the tire is a surface of one of the sidewalls of the tire.

18. A process for coating a tire according to claim 1 comprising:
treating a tire surface to render the elastomers of the surface polar, wherein the elastomers are functionalized,
applying at least one layer of a colored composition based on polyurethane to the treated surface of the tire, and
drying the at least one layer until a colored coating forms.

19. The process according to claim 18, wherein the tire surface is treated with a functionalizing agent selected from the group consisting of trichloroisocyanuric acid, alkaline hypochlorites, and alkaline-earth hypochlorites in hydrochloric acid.

20. The process according to claim 18, wherein the composition comprises polyurethane in a concentration between 10 and 50% by weight.
